(19) United States
(12) Patent Application Publication
(10) Pub. No.: US 2014/0101534 A1
(43) Pub. Date: Apr. 10, 2014

(54) METHOD OF AUTHORING XML DOCUMENT AND APPARATUS FOR PERFORMING THE SAME

(71) Applicant: Electronics & Telecommunications Research Institute, Daejeon (KR)

(72) Inventor: You Hee CHOI, Daejeon (KR)

(73) Assignee: Electronics & Telecommunications Research Institute, Daejeon (KR)

(21) Appl. No.: 14/049,092

(22) Filed: Oct. 8, 2013

(30) Foreign Application Priority Data
Oct. 9, 2012 (KR) 10-2012-0111627

(51) Int. Cl. G06F 17/24

(52) U.S. Cl. CPC G06F 17/24
USPC 715/234

(57) ABSTRACT

Disclosed are a method of authoring an XML document and an apparatus for performing the same. The XML document authoring method includes generating a unified modeling language (UML) activity diagram model corresponding to provided contents, based on a predefined UML generation rule, and generating an XML document corresponding to the UML activity diagram model based on a predefined mapping rule, so that main contents of a text-based procedural data module are visually displayed, and thus a user easily recognizes the contents of the procedural data module, and easily generates an S1000D procedural data module XML file without having to learn an S1000D XML schema.

### CLAIM FOR PRIORITY

This application claims priority to Korean Patent Application No. 10-2012-0111627 filed on Oct. 9, 2012 in the Korean Intellectual Property Office (KIPO), the entire contents of which are hereby incorporated by reference.

### BACKGROUND

1. Technical Field

Example embodiments of the present invention relate in general to the field of document automatic authoring, and more specifically to a method of authoring an XML document that is applied to the generation of an S1000D procedural data module and an apparatus for performing the same.

2. Related Art

S1000D is a specification developed as a standard format for writing technical documents about various apparatuses used in aerospace and defense industries. S1000D enables technical data about various apparatuses to be systemically classified and specified in an Extensible Markup Language (XML) format.

Before the development of the S1000D standard, most technical documents were described in various formats and various structures, and the data quality of the technical documents had a large variation, and thus there was a disadvantage associated with comprehending and managing technical data.

The S1000D standard is developed to resolve such drawbacks by systematically classifying equipment and information using a standard generalized markup language (SGML) and an XML document format, and by defining a writing form according to data contents while having data module information as a minimum unit for identification.

XML is a markup language that defines a set of rules to encode documents. XML has a text data format, and is designed to deliver data rather than to display data.

In addition, XML may define various XML tag structures according to XML documents and XML schemas. Such a characteristic of XML requires a user to previously learn the meaning of XML tags according to a predefined XML scheme, and is not easy for a user to verify whether a document is correctly written according to the meaning and structure of the XML tags without using a tool.

For this reason, various XML editing tools having a function to automatically complete a tag, a function to verity XML in real time, and a function to display a tag structure in a tree view are developed. In addition, there are various tools for displaying XML documents in a form that is easy for a user to comprehend data rather than in the XML form, by use of an extensible stylesheet language transformation (XSLT) style sheet. However, even with such an XML editing tool, a user has difficulty in writing XML documents without learning the S1000D schema or tag structures in advance.

Meanwhile, most technical data about apparatuses needed in the aerospace and defense industries involve technical manuals. Such a technical manual in some cases describes the apparatuses, but mainly delivers information related to a procedure of installation, management, and maintenance of the apparatuses. Accordingly, an S1000D specification defines a procedual data module XML document format to describe procedure information.

If procedure information is described in a visual method, such as a flowchart, a user may effectively comprehend main contents, and without having knowledge of XML tags, may intuitively define procedural data as the main information is procedure information.

However, in case of procedure information authored in XML, unless the contents of the procedure information are converted into any other form and a user has learned the meaning of XML tags, the contents are not easily comprehended.

Accordingly, there is a need for a method for easily authoring XML documents in a visual manner and enabling a user to easily comprehend the contents without knowing the meaning of XML tags. Unified modeling language (UML), which is widely used as a visual modeling language, supports dynamic information, such as a procedure, as well as static information.

Meanwhile, in the convention technology, in order to express XML and XML schema including static data structure, an UML class module, which is referred to as a static module, is used.

The UML class model is a diagram that represents a static relation between model elements constituting a problem domain. Accordingly, for the S1000 specification including procedure information that is dependent on time elapse and event occurrence, such as, installation, management, and maintenance of apparatuses, there is a limitation in describing procedure information using a UML class diagram.

### SUMMARY

Accordingly, example embodiments of the present invention are provided to substantially obviate one or more problems due to limitations and disadvantages of the related art.

Example embodiments of the present invention provide a method of authoring XML documents for easily generating an UML activity model without having knowledge of an XML schema or an UML model, and thus automatically generating XML documents.

Example embodiments of the present invention also provide an apparatus for authoring XML documents for performing the XML authoring method.

In some example embodiments, a method of authoring an extensible markup language (XML) document includes generating a unified modeling language (UML) activity diagram model corresponding to provided contents, based on a predefined UML generation rule, and generating an XML document corresponding to the UML activity diagram model based on a predefined mapping rule.

The generating of the UML activity diagram model may include providing a list of elements of a procedural data module through a user interface, and generating the UML activity diagram model based on a definition and/or property about a selected element from the list of elements. Alternatively, the generating of the UML activity diagram to model may include providing a user interface to define at least one property among a name, a pre-condition, a unit procedure, a reference element, safety information, a post-condition, and an inter-element link line of a procedural data module, and generating an UML activity diagram model element corresponding to an element selected among the at least one element, according to a type of the selected element and presence of input attributes.

In the generating of the UML activity diagram model, if the name of the procedural data module is provided, a new activity element may be generated or an activity element including an existing activity or action may be generated, depending on existence of an UML activity element or an UML action element. Alternatively, in the generating of the UML activity diagram model, if a definition of the pre-condition of the procedural data module is selected, an UML activity diagram model element that is defined with a different stereotype depending on existence of a reference object of the pre-condition may be generated. In the generating of the UML activity diagram model, if a definition of the unit procedure of the procedural data module is selected, one of an activity element and an action element may be generated depending on existence of a dependent procedure. In the generating of the UML activity diagram model, if a definition of the reference element of the procedural data module is selected, an UML comment element corresponding to a type of an input reference element may be generated. In the generating of the UML activity diagram model, if a definition of the post-condition of the procedural data module is selected, depending on existence of a reference element, an UML comment element that is defined with a stereotype may be generated or a stereotype pointing to a post-condition may be generated in an activity element containing the name of the procedual data module.

The user interface may include a toolbar to define the at least one element, an UML model edit window on which content of the element selected among the at least one element, and a property edit window for property editing.

The predefined mapping rule may be a definition about a type and usage form of an XML tag corresponding to a link and a reference relationship of UML activity diagram elements including at least one of an activity element, an action element, a pre-condition, a post-condition, an external reference element, an internal reference element, a unit procedure, and a safety element.

In other example embodiments, an apparatus for authoring an XML document includes an input unit, a processing unit, and an output unit. The input unit may be configured to receive contents. The processing unit may be configured to generate an unified modeling language (UML) activity diagram model according to the provided contents, and generate an extensible markup language (XML) document corresponding to the generated UML activity diagram model. The output unit may be configured to display a user interface to generate the UML activity diagram model and the XML document.

The processing unit may perform at least one of a procedural data module edit function to compose contents of procedural data module elements, an UML activity diagram model property edit function to edit properties of the generated UML activity diagram model, and an XML file edit function to edit the generated XML document.

As is apparent from the above, the method of authoring XML documents and the apparatus for performing the same can support a user interface enabling a user to visually write S1000D procedural data module elements, automatically generate an UML activity diagram model according to an UML model generation rule, and generate an S1000D procedural data module XML file corresponding to the UML activity diagram model by use of a mapping rule.

Accordingly, main contents of a text-based procedural data module are visually displayed, and thus a user can easily recognize the contents of the procedural data module.

In addition, a user can easily generate an S1000D procedural data module XML to file without having to learn an S1000D XML schema.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method of authoring an XML document in accordance with an example embodiment of the present disclosure;

FIG. 2 is a functional block diagram illustrating a configuration of an apparatus for authoring an XML document in accordance with an example embodiment of the present disclosure;

FIG. 3 is a block diagram illustrating a hardware configuration of the XML document authoring apparatus in accordance with an example embodiment of the present disclosure;

FIG. 4 is a conceptual view illustrating a user interface that is provided in a process of performing the XML document authoring method in accordance with an example embodiment of the present disclosure;

FIGS. 5A and 5B are flowcharts illustrating an UML activity diagram model generation rule using each element of a toolbar shown in FIG. 4;

FIGS. 6A and 6B are drawings illustrating a mapping rule between an UML model and an S1000D procedural data module XML file used in the XML document authoring method in accordance with an example embodiment of the present disclosure;

FIG. 7 is a drawing illustrating an example of an UML activity diagram model that is generated in a process of authoring an XML document in accordance with an example embodiment of the present disclosure; and

FIGS. 8A, 8B, and 8C are drawings illustrating an example of generating an to S1000D procedural data module XML document corresponding to the UML activity diagram model shown in FIG. 7.

### DESCRIPTION OF EXAMPLE EMBODIMENTS

Example embodiments of the present invention are disclosed herein. However, specific structural and functional details disclosed herein are merely representative for purposes of describing example embodiments of the present invention, and thus example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in reverse order, depending upon the functionality/acts involved.

Hereinafter, embodiments of the present invention will be described in detail with reference to the accompanying drawings. For clarity, elements that appear in more than one drawing or in more than one place in the description are consistently denoted by the same respective reference numerals, and such elements are only described in detail once, to avoid redundancy.

A method of authoring an XML document in accordance with an example embodiment of the present disclosure may be applied to environments of authoring various types of documents, but for convenience sake, the XML document authoring method in accordance with an example embodiment is illustrated as being applied to an S1000D standard. In particular, in accordance with an example embodiment of the present disclosure, a method for automatically generating an S1000D procedural data module XML file is provided.

In addition, with the XML document authoring method in accordance with an example embodiment of the present disclosure, in consideration that the information desired to generate in an XML file is procedure information, an unified modeling language (UML) activity diagram model, which is one of models that model dynamic information, such as procedure information, is defined in an extensible manner so as to represent procedure information.

In addition, since the UML is also referred to as a formal modeling language, detailed rules for an UML modeling exist. In accordance with the present disclosure, a method of automatically generating an UML activity diagram model and automatically generating an S1000D procedural data module based on the generated UML activity diagram model as a user writes procedure information in the same way as writing a text manual without using a general UML modeling tool, is provided such that a user may intuitively write a procedural data module without knowing the detailed rules.

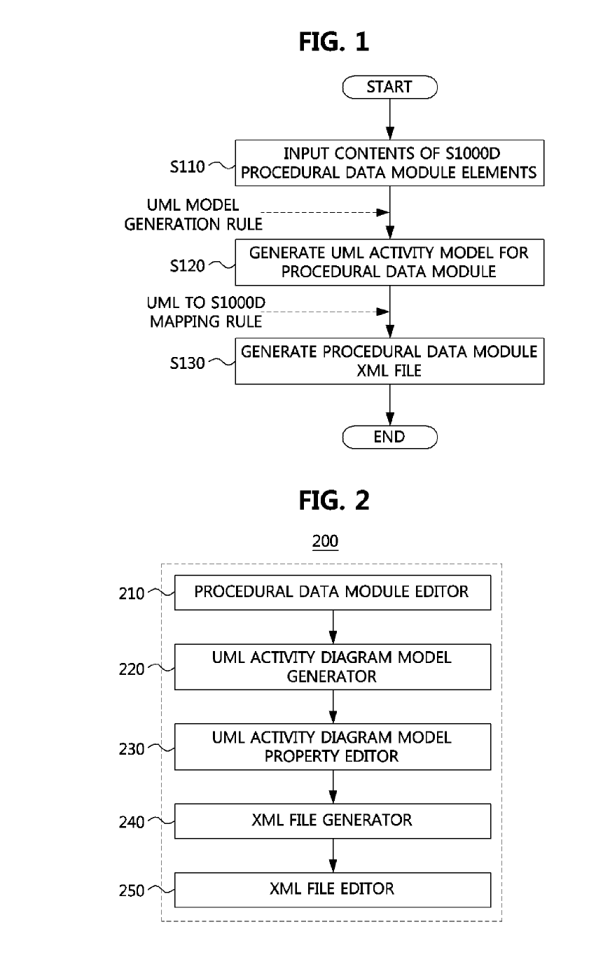

FIG. 1 is a flowchart illustrating a method of authoring an XML document in accordance with an example embodiment of the present disclosure, showing an example of a process of generating an S1000D procedural data module in the form of an XML file.

The XML document authoring method in accordance with an example embodiment of the present disclosure enables a user to automatically generate an S1000D procedural data module XML file without having knowledge of an S1000D XML schema when initially writing an S1000D procedural data module.

First, an XML document authoring apparatus receives contents of main elements of an S1000D procedural data module that are written by a user (S110). Here, in order for a user to write a new procedural data module without having to learn an S1000D XML schema, the XML document authoring apparatus provides a list of main elements of the procedural data module through a user interface such that a user selects a desired element from the provided list of elements of the procedural data module, and writes main contents of a corresponding item.

Thereafter, the XML document authoring apparatus generates an UML activity diagram model according to the element contents of the S1000D procedural data module that are written by the user (S120). Here, the XML document authoring apparatus, based on an UML model generation rule, generates an UML activity diagram model corresponding to elements of the S1000D procedural data module written by the user.

Thereafter, the XML document authoring apparatus generates an S1000D procedural data module XML file based on the generated UML activity diagram model (S130). Here, the XML document authoring apparatus may generate the S1000D procedural data module XML file based on a predefined mapping rule between the UML activity diagram model and the S1000D procedural data module XML file.

FIG. 2 is a functional block diagram illustrating a configuration of an apparatus for authoring an XML document in accordance with an example embodiment of the present disclosure, showing an example of a functional configuration of an apparatus for generating an S1000D procedural data module in the form of an XML document.

Referring to FIG. 2, an XML document authoring apparatus 200 in accordance with an example embodiment of the present disclosure may include a procedural data module editor 210, an UML activity diagram model generator 220, an UML activity diagram model property editor 230, an XML file generator 240, and an XML file editor 250.

The procedural data module editor 210 allows contents of an S1000D procedural data module to be composed by use of S1000D procedural data module elements. Here, the procedural data module editor 210 provides a list of elements of the S1000D procedural data module through a user interface such that a user who writes the S1000D procedural data module selects a desired element from the list of elements of the S1000D procedural data module, and defines basic contents of the S1000D procedural data module.

The UML activity diagram model generator 220 automatically generates an UML activity diagram model for the procedural data module based on the defined contents of the S1000D procedural data module provided by the procedural data module editor 210. Here, the UML activity diagram model generator 220 generates UML activity diagram model elements for the procedural data module according to types of the defined elements of the S1000D procedural data module.

The UML activity diagram model property editor 230 allows a user to edit properties of the UML activity diagram model for the procedural data module that is automatically generated by the UML activity diagram model generator 220. Here, the UML activity diagram model property editor 230 provides a user interface such that detailed elements required to write an S1000D procedural data module XML file are defined with respect to the UML activity diagram model that is automatically generated.

The XML file generator 240 receives the UML activity diagram model for the procedural data module having property information added thereto, and automatically generates an S1000D procedural data module XML file corresponding to the received UML activity diagram model.

The XML file editor 250 allows the S1000D procedural data module XML file, which is automatically generated, to be edited. Here, the XML file editor 250 may provide a user interface allowing a user to additionally write an optional element that is required for the automatically generated S1000D procedural data module XML file based on mandatory elements.

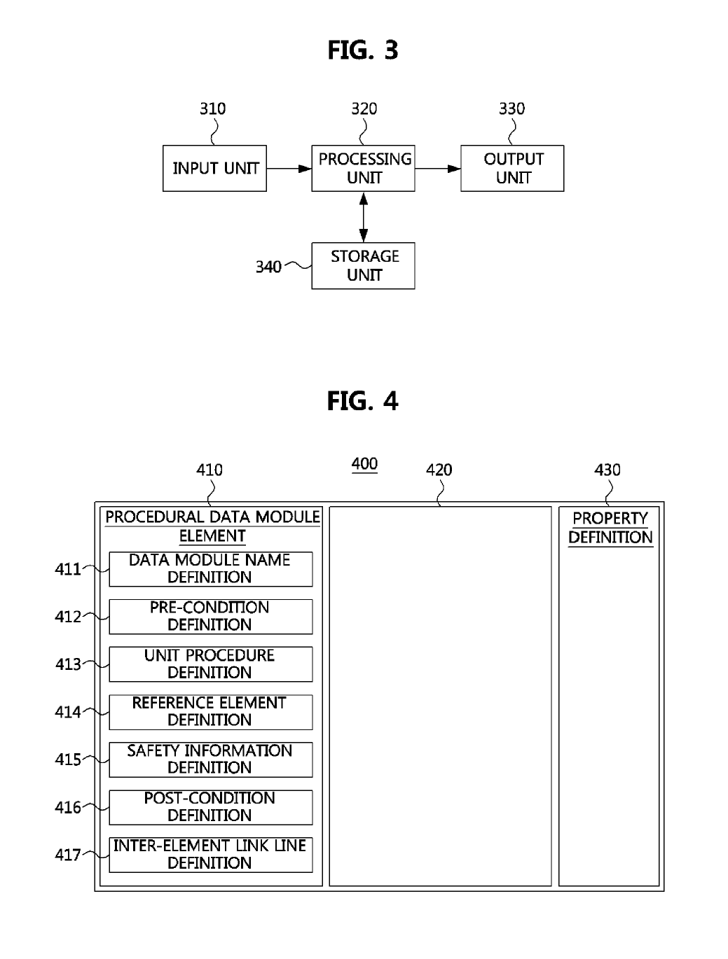

FIG. 3 is a block diagram illustrating a hardware configuration of the XML document authoring apparatus in accordance with an example embodiment of the present disclosure.

Referring to FIG. 3, the XML document authoring apparatus in accordance with an example embodiment of the present disclosure may include an input unit 310, a processing unit 320, an output unit 330, and a storage unit 340.

The input unit 310 may be implemented as a device configured to receive characters, numbers, symbols, and special functions from a user, and to provide the processing unit 320 with contents of the elements of the S1000D procedural data module that are input by a user. The input unit 310 may be implemented as various input devices, for example, a keypad, a keyboard, a touchscreen, and a touchpad.

The processing unit 320 may be implemented as a processor. The processing unit 320 generates an UML activity diagram model according to contents of the elements of the S1000D procedural data module provided by the user through the input unit 310, and generates an S1000D procedural data module XML file based on the generated UML activity diagram model.

In addition, the processing unit 320 provides a user interface for editing the procedural data module, a user interface for editing properties of the UML activity diagram model, and a user interface for editing the S1000D procedural data module XML file.

That is, the processing unit 320 may substantially perform the functions of the procedural data module editor 210, the UML activity diagram model generator 220, the UML activity diagram model property editor 230, the XML file generator 240, and the XML file editor 250 that are shown in FIG. 2.

The output unit 330 may be implemented as a display device, and may display user interface screens for editing the procedural data module, the properties of the UML activity diagram model, and the XML file according to a control of the processing unit 320. In addition, the output unit 330 may display various processing result screens, such as the UML activity diagram model and the S1000D procedural data module XML document that are generated in the XML document authoring process.

The storage unit 340 may store programs that perform the procedural data module editing function, the UML activity diagram model generation function, the UML activity diagram model property editing function, and the XML file generation/editing function, and store the S1000D procedural data module XML file generated by the processing unit 320.

FIG. 4 is a conceptual view illustrating a user interface that is provided in a process of performing the XML document authoring method in accordance with an example embodiment of the present disclosure, schematically showing a part of a user interface of an S1000D procedural data module generating tool.

Referring to FIG. 4, a user interface 400 in accordance with an example embodiment of the present disclosure may mainly include a toolbar 410, an UML model edit window 420, and a property definition window 430.

The toolbar 410 is an arrangement of main elements required to constitute an S1000D procedural data module. The toolbar 410 is configured to, if a user selects elements from the toolbar 410, display contents corresponding to the selected elements on the UML model edit window 420, and if the user clicks a certain position on the UML model edit window 420, generate a model element corresponding to the click position. The property definition window 430 allows main contents of each element to be edited, and items editable in the property definition window 430 are represented differently with the type of the element selected by the user from the toolbar 410.

The toolbar 410 includes elements such as a data module name definition 411, a pre-condition definition 412, a unit procedure definition 413, a reference element definition 414, a safety information definition 415, a post-condition definition 415, and an inter-element link line definition 417, and supports the following functions according to user selection.

The data module name definition 411 is an element configured to support generation of an element that specifies a name of a data module.

The pre-condition definition 412 is an element configured to support generation of an element that defines a pre-condition that represents a condition and an action needed to be satisfied before a procedure specified in a data module is performed.

The unit procedure definition 413 is an element configured to support definition of a unit procedure element that composes a single procedure.

The reference element definition 414 is an element configured to specify a reference element if the reference element is present in a data module.

The safety information definition 415 is an element configured to support definition of safety requirements needed in performing a procedure in a data module.

The post-condition definition 416 is an element configured to support generation of an element that defines a post-condition that represents a condition and an action needed to be satisfied after a procedure specified in a data module is performed.

The inter-element link line definition 417 is an element configured to support definition of a sequence and a link relationship of procedures.

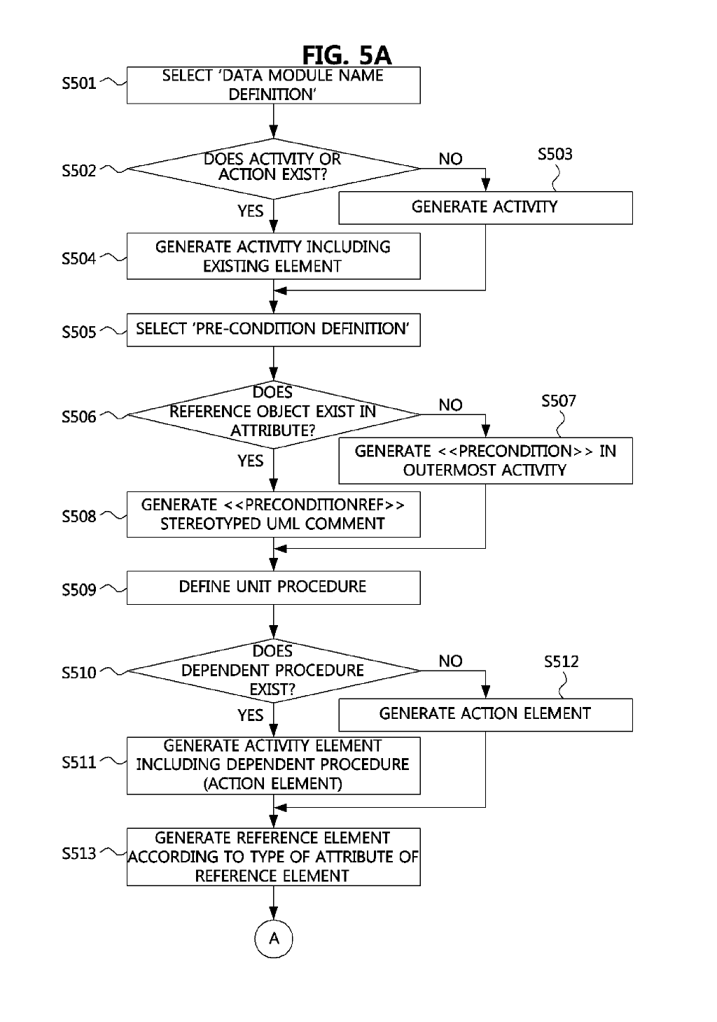

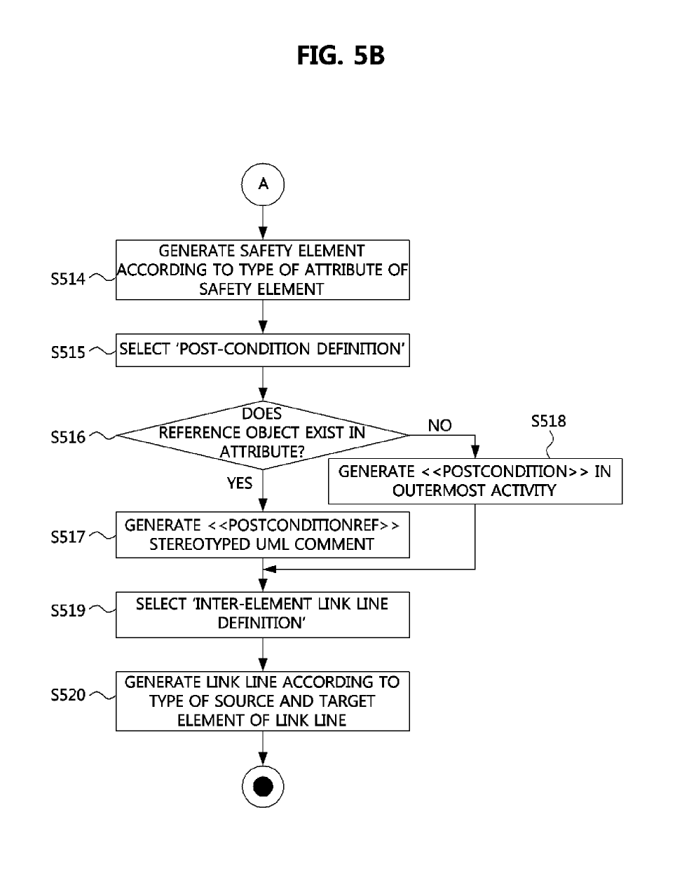

FIGS. 5A and 5B are flowcharts illustrating an UML activity diagram model generation rule using each element of the toolbar shown in FIG. 4, showing a method of generating an UML activity diagram model as a user selects each element of the toolbar 410 of FIG. 4 and places the selected element on the UML model edit window 420.

The UML activity diagram model generated in the XML document authoring process in an example embodiment of the present disclosure is a model that is defined in an extensible manner by use of an UML extension mechanism to specify an S1000D procedural data module.

Hereafter, an UML activity diagram model generation rule in accordance with an example embodiment of the present disclosure will be described in detail with reference to FIGS. 4, 5A, and 5B.

First, when a user selects the data module name definition 411 to define a title of a data module and defines the title of the data module by use of the property definition window 430 (S501), the XML document authoring apparatus determines whether an UML Activity element or an UML Action element already exists on the UML model edit window 420 (S502). Here, the UML Action element represents a task that is not decomposed any further, and the UML Activity element is a procedure unit that may be decomposed into an Action or another Activity.

If it is determined from operation S502 that an UML Activity or Action element does not exist on the UML model edit window 420, the XML document authoring apparatus generates an Activity element and displays the generated Activity element on the UML model edit window 420 (S503).

Alternatively, if it is determined from operation S502 that an UML Activity or Action element exists on the UML model edit window 420, the XML document authoring apparatus generates an Activity element including the existing element (Activity or Action), and displays the generated Activity element on the UML model edit window 420 (S504). The Activity element generated in operation S504 is generated outside the existing element so as to include the previously generated element.

Thereafter, in case a user selects the pre-condition definition 412 to define a pre-condition of the data module (S505), an UML model element is generated differently depending on the existence of an object that is referenced by the pre-condition.

Accordingly, the XML document authoring apparatus determines whether the reference object is present in properties (S506), and in case a user inputs a reference element into the property definition window 430, generates an element in the form of an UML Comment element, which is defined with <<ExternalReference>> stereotype, linked with an UML Comment element, which is defined with <<PreconditionRef>> stereotype, and displays the generated element on the UML model edit window 420 (S508) so that a pre-condition including the reference element is specified.

Alternatively, in case a user does not input a reference element into the property definition window 430, the XML document authoring apparatus generates <<precondition>> stereotype in the Activity element, which is generated from selection of the data module name definition 411, and displays the generated element (S507).

If the user selects the unit procedure definition 413 (S509), and selects a certain position on the UML model edit window 420, the XML document authoring apparatus determines whether a dependent procedure exists at the position selected by the user (S510), and according to the determination result, generates one of an Activity element and an Action element (S511).

For example, selecting, by a user, an inside of a previously generated unit procedure element on the UML model edit window 420 represents desiring generation of a dependent procedure that is dependent on another procedure. Accordingly, the XML document authoring apparatus changes the previously generated unit procedure into an Activity element according to semantic, and generates a dependent procedure (for example, an Action element) that is included in the Activity element. Alternatively, in case a user selects an area other than the inside of the unit procedure element on the UML model edit window 420, that is, in case a user desires to generate a unit procedure having no dependent procedure, the XML document authoring apparatus generates an Action element according to semantic (S512).

In case a user selects the reference element definition 414, and edits or defines a reference element through the property definition window 430, the XML document authoring apparatus generates a reference element according to the type of the reference element that is edited or defined by the user on the property definition window 430 (S513). Here, types of reference elements selectable by a user through the property definition window 430 may include External Reference, Internal Reference, Supported Equipment, Supply, and Spare.

In case a user selects the External Reference element among the reference elements, the XML document authoring apparatus generates an UML Comment element in which <<ExternalReference>> stereotype is defined. Alternatively, in case a user selects the Internal Reference element corresponding to an internal reference, such as a picture and a table, among the reference elements, the XML document authoring apparatus generates an UML Comment element in which <<InternalReference>> stereotype is defined. In addition, Supported Equipment, Supply, and Spare are elements needed to be essentially expressed, and thus distinctively expressed from other internal reference elements. Accordingly, in case a user selects the Supported Equipment element, the Supply element, and the Spare element, the XML document authoring apparatus generates an UML Comment element to which <<SupportedEquipment>> stereotype is applied, an UML Comment element to which <<Supply>> stereotype is applied, and an UML Comment element to which <<Spare>> stereotype is applied with respect to the selected Supported Equipment element, Supply element, and Spare element, respectively.

In case a user selects the safety information definition 415 and selects one safety element between Warning and Caution, the XML document authoring apparatus generates an UML Comment element in which a stereotype corresponding to a safety element selected by the user is defined, that is, an UML Comment element in which <<Warning>> stereotype is defined or an UML Comment element in which <<Caution>> stereotype is defined (S514).

In case a user selects the post-condition definition 416 (S515), the XML document authoring apparatus determines whether a reference object exists in the properties (S516). Here, inputting, by a user, a reference element in the property definition window 430 is to specify a post-condition including a reference element. Accordingly, the XML document authoring apparatus generates an element in the form of an UML Comment element, which is defined with <<ExternalReference>> stereotype, linked with an UML Comment element, which is defined with <<PostconditionRef>> stereotype, and displays the generated element (S517).

Alternatively, in case a user does not input a reference element into the property definition window 430, the XML document authoring apparatus generates a <<postcondition>> stereotype in the Activity element that is generated from selection of the data module name definition 411, and displays the Activity element having the <<postcondition>> stereotype (S518).

In case a user selects the inter-element link line definition 417 and selects two elements needed to be linked (S519), the XML document authoring apparatus generates a link line, conforming to a rule that is defined in UML, according to the type of the selected element (S520). For example, if a user selects two unit procedure elements needed to be linked, the XML document authoring apparatus generates a UML Control Flow between the selected unit procedure elements. Alternatively, if a user selects a unit procedure and an external reference/internal reference element, a unit procedure and a pre-condition/post-condition element, a unit procedure and a safety element, or a unit procedure and a Supported Equipment/Supply/Spare element, the XML authoring apparatus generates an UML Note Link between the selected two elements each.

The automatic generation of information as described above is only an example of a part of the functions of the XML document authoring apparatus in accordance with an example embodiment of the present disclosure. The XML document authoring apparatus in accordance with an example embodiment of the present disclosure supports specification of various detailed properties and tag information that are needed to be essentially expressed in the S1000D procedural data module through the property definition window 430 as well as the automatic generation of information in the above described XML document authoring process.

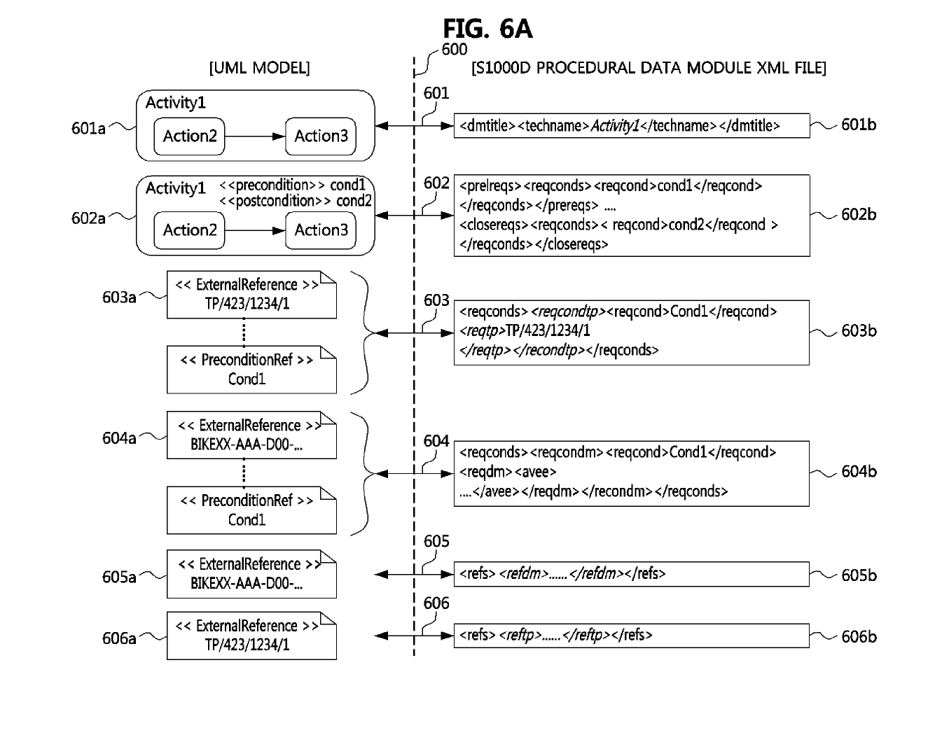

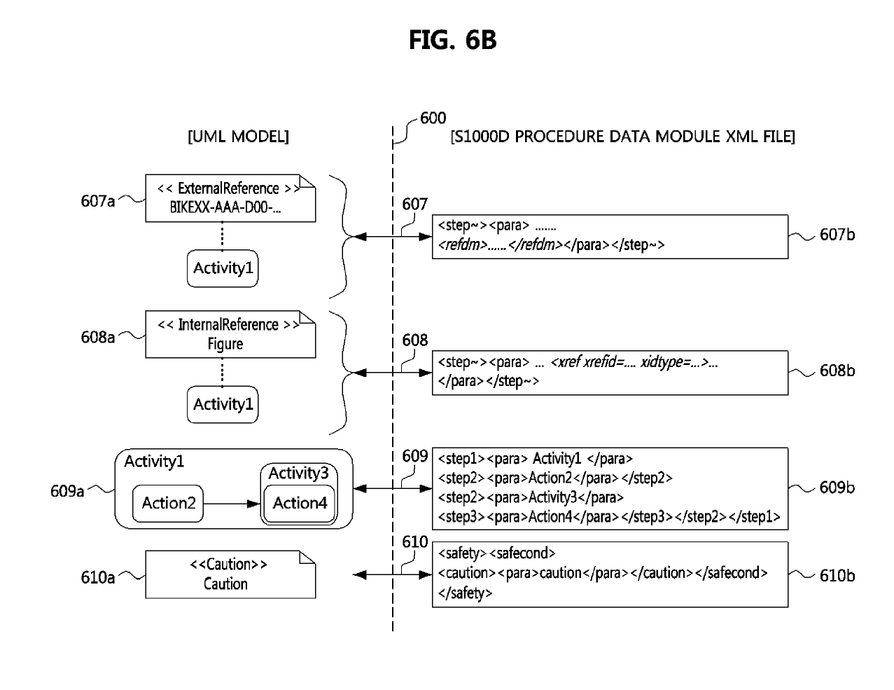

FIGS. 6A and 6B are drawings illustrating a mapping rule between an UML model and an S1000D procedural data module XML file used in the XML document authoring method in accordance with an example embodiment of the present disclosure.

On the left portion of a dotted line 600 in FIGS. 6A and 6B, UML model elements used to generate an S1000D procedural data module are shown.

Here, a quadrangle having round corners represents an Activity or Action element, and a rectangle having a right side corner folded represents constraints, note, or text information and is connected to a related model element through a dotted line. Meanwhile, on the right portion of the dotted line 600, elements of the S1000D procedural data module XML file corresponding to the UML model elements, respectively, are shown.

An outermost Activity element in the UML model (for example, an element denoted as reference numeral 601a) is an Activity that represents the entire procedure of the S1000D procedural data module, and an Activity name (for example, ‘Activity1’) of the Activity is mapped to contents of <techname> element of <dmtitle> in the S1000D procedural data module XML file as shown in 601b (601).

Pre-condition/post-condition including no reference element are expressed on a representative Activity 602a by use of <<precondition>> stereotype and <<postcondition>> stereotype, and mapped as shown in 602b (602).

Pre-condition/post-condition including an external reference element, if the external reference element is not in a data module code format (see an item 603a), are mapped as shown in 603b (603), and if the external reference element is in a data module code format (see an item 604a), are mapped as shown in 604b (604).

An external reference element is an item that needs to be separately expressed as a reference element list in the S1000D procedural data module. In the UML model, if an external reference element expressed with <<ExternalReference>> stereotype is provided in a data module code format (see an item 605a), the external reference element is mapped as shown in 605b (605). Alternatively, if an external reference element expressed with <<ExternalReference>> stereotype is not provided in a data module code format (see an item 606a), the external reference element is mapped as shown in 606b (606).

An item 607a represents a case in which an external data module is referred to by Activity expressing a unit procedure (Activity1), and is mapped as shown in 607b (607).

An item 608a represents an area that substantially refers to an internal reference element that is expressed with <<InternalReference>> stereotype in the UML model, and is mapped as shown in 608b (608).

An item 609a represents a unit procedure of an S1000D procedural data module expressed using an UML Activity or UML Action element, in which an Action2 and an Activity3 are procedures dependent on the Activity1 and an Action4 is a procedure dependent on the Activity3. A case as shown in 609a in which a procedure includes dependent procedures thereof is mapped as shown in 609b depending on whether a certain procedure is dependent on another procedure (609).

An item 610a represents a Caution element, which is one of safety elements, expressed using <<Caution>> stereotype, and is mapped as shown in 610b (610).

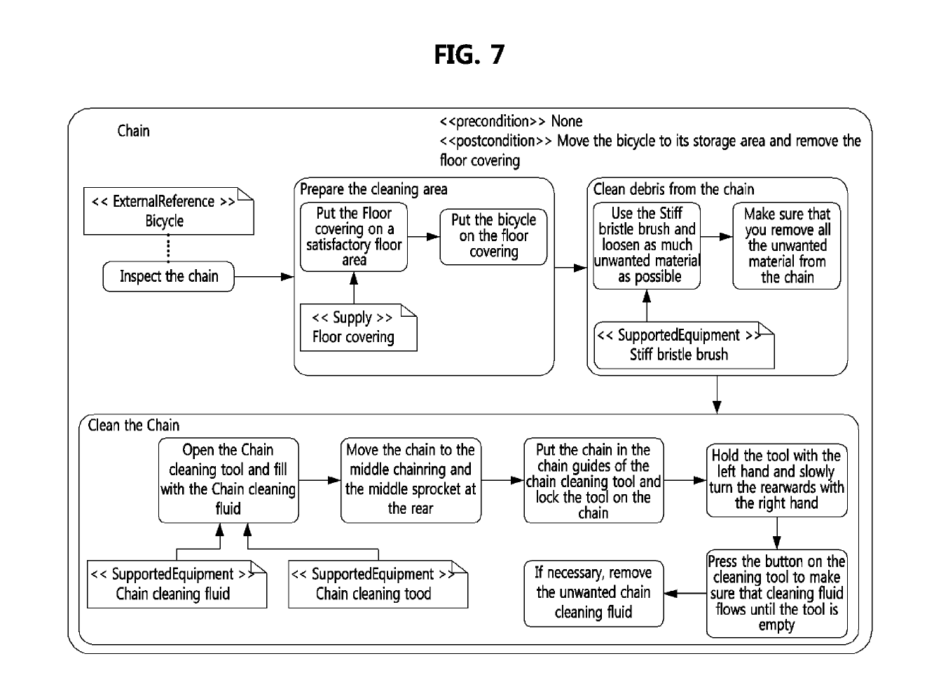

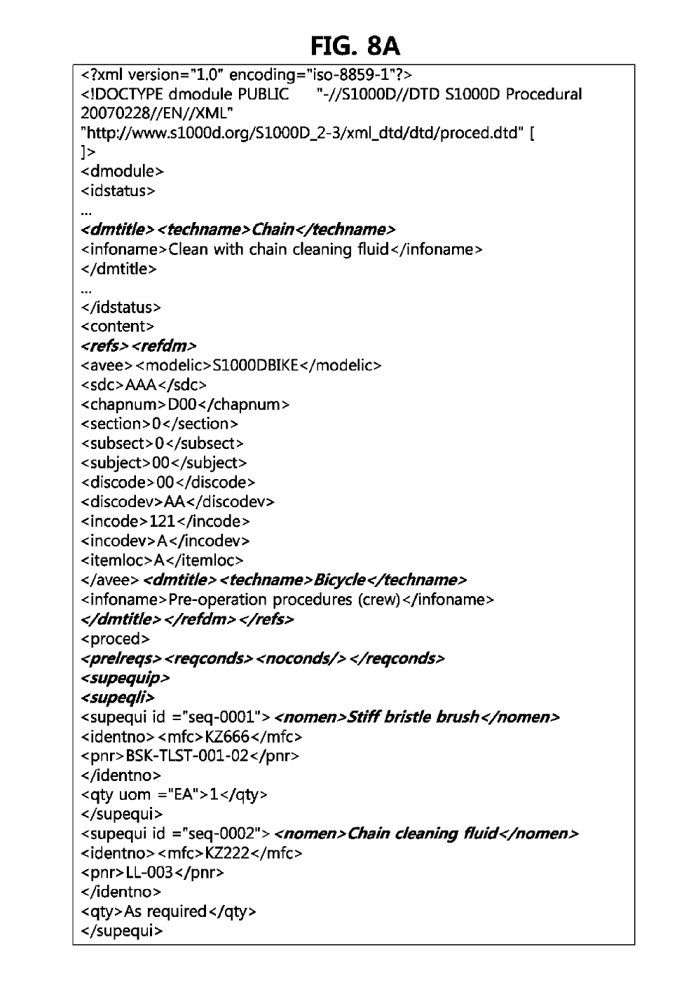

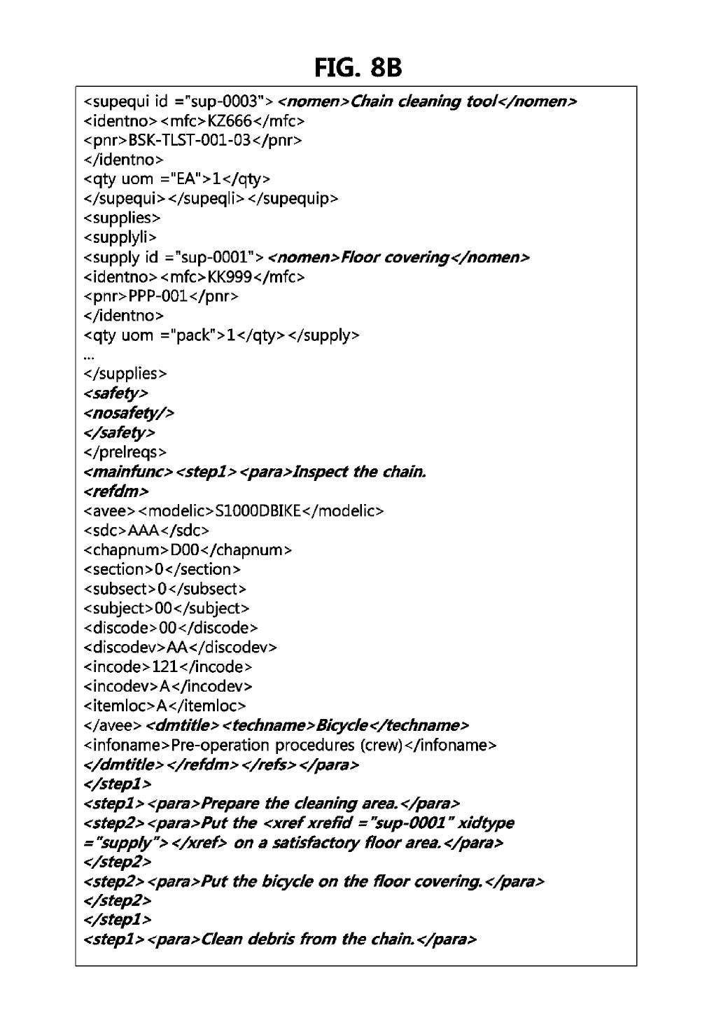

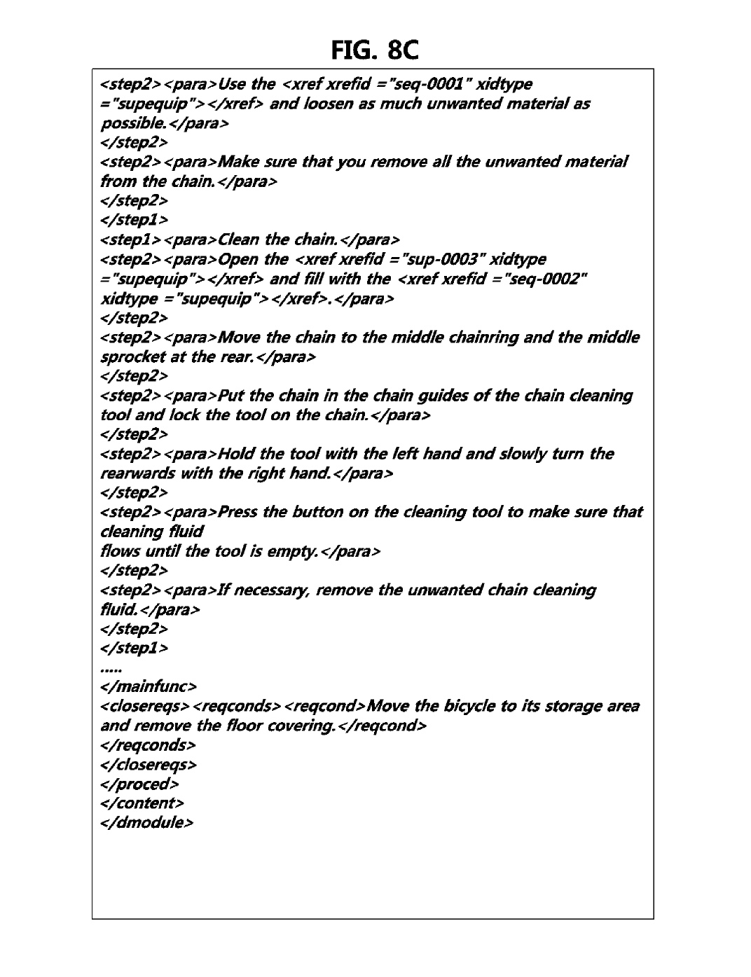

FIG. 7 is a drawing illustrating an example of an UML activity diagram model that is generated in a process of authoring an XML document in accordance with an example embodiment of the present disclosure. FIGS. 8A, 8B, and 8C are drawings illustrating an example of an S1000D procedural data module XML document corresponding to the UML activity diagram model shown in FIG. 7.

FIG. 7 shows an example of generating an UML activity diagram model provided to generate main contents of an S1000D procedural data module XML file with respect to a procedure of cleaning a chain of a bicycle using a cleaning fluid, in which a visual UML activity diagram model is automatically generated from text-based contents input by a user.

Referring to FIG. 7, the UML activity diagram model expresses an Activity that represents the entire procedure of cleaning the chain of the bicycle as “Chain”, and displays pre-condition and post condition. In addition, Activity elements, such as “Inspect the chain,” “Prepare the cleaning area,” “Clean debris from the chain,” and “Clean the chain” are composed, according to a work procedure in the Chain Activity element, and connected to each other in an arrow according to a work flow. In addition, in case a dependent procedure is needed in each Activity element, the needed dependent procedure is composed as an Activity element or an Action element. A reference element of the Activity or Action is expressed to be connected to the Activity or Action in an arrow or a dotted line.

FIGS. 8A, 8B, and 8C illustrates an example of automatically generating an S1000D procedural data module XML document from the UML activity diagram model of FIG. 7 based on the mapping rule shown in FIGS. 6A and 6B.

A bold italicized portion in FIGS. 8A, 8B, and 8C represents a part automatically generated only using the UML activity diagram model information shown in FIG. 7, and the remaining portion represents a part generated based on property information that is additionally written by a user through the property definition window 430 of the user interface of FIG. 4.

While the example embodiments of the present invention and their advantages to have been described in detail, it should be understood that various changes, substitutions, and alterations may be made herein without departing from the scope of the invention.

What is claimed is:

1. A method of authoring an extensible markup language (XML) document, the method comprising:
generating a unified modeling language (UML) activity diagram model corresponding to provided contents, based on a predefined UML generation rule; and
generating an XML document corresponding to the UML activity diagram model based on a predefined mapping rule.

2. The method of claim 1, wherein the generating of the UML activity diagram model comprises:
providing a list of elements of a procedural data module through a user interface; and
generating the UML activity diagram model based on a definition and/or property of content that is input with respect to a predetermined element selected from the list of elements.

3. The method of claim 1, wherein the generating of the UML activity diagram model comprises:
providing a user interface to define at least one element among a name, a pre-condition, a unit procedure, a reference element, safety information, a post-condition, and an inter-element link line of a procedural data module; and
generating an UML activity diagram model element corresponding to an element selected among the at least one element, according to a type of the selected element and presence of input properties.

4. The method of claim 3, wherein in the generating of the UML activity diagram model, if the name of the procedural data module is provided, a new activity element is generated or an activity element including an existing activity or action is generated, depending on existence of an UML activity element or an UML action element.

5. The method of claim 3, wherein in the generating of the UML activity diagram model, if a definition of the pre-condition of the procedural data module is selected, an UML activity diagram model element that is defined with a different stereotype depending on existence of a reference object of the pre-condition is generated.

6. The method of claim 3, wherein in the generating of the UML activity diagram model, if a definition of the unit procedure of the procedural data module is selected, one of an activity element and an action element is generated depending on existence of a dependent procedure.

7. The method of claim 3, wherein in the generating of the UML activity diagram model, if a definition of the reference element of the procedural data module is selected, an UML comment element corresponding to a type of an input reference element is generated.

8. The method of claim 3, wherein in the generating of the UML activity diagram model, if a definition of the post-condition of the procedural data module is selected, depending on existence of an input reference element, an UML comment element that is defined with a stereotype is generated or a stereotype pointing to a post-condition is generated in an activity element that is generated according to the definition of the name of the procedural data module.

9. The method of claim 3, wherein the user interface includes a toolbar to define the at least one element, an UML model edit window on which content of the element selected among the at least one element, and a property edit window for property editing.

10. The method of claim 1, wherein the predefined mapping rule is a definition about a type and usage form of an XML tag corresponding to a link and a reference relationship of UML activity diagram elements including at least one of an activity element, an action element, a pre-condition, a post-condition, an external reference element, an internal reference element, a unit procedure, and a safety element.

11. An apparatus for authoring an XML document, the apparatus comprises:
an input unit configured to receive contents;
a processing unit configured to generate an unified modeling language (UML) activity diagram model according to the provided contents, and generate an extensible markup language (XML) document corresponding to the generated UML activity diagram model; and
an output unit configured to display a user interface to generate the UML activity diagram model and the XML document.

12. The apparatus of claim 11, wherein the processing unit performs at least one of a procedural data module edit function to compose contents of procedural data module elements, an UML activity diagram model property edit function to edit properties of the generated UML activity diagram model, and an XML file edit function to edit the generated XML document.
